(19) United States
(12) Patent Application Publication
(10) Pub. No.: US 2009/0237356 A1
(43) Pub. Date: Sep. 24, 2009

(54) OPTICAL POINTING DEVICE

(75) Inventors: Oliver M. C. Williams, San Francisco, CA (US); Andrew W. Fitzgibbon, Cambridge (GB)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/053,628

(22) Filed: Mar. 24, 2008

(51) Int. Cl. G06F 3/033; G03H 1/00

(52) U.S. Cl. 345/157; 359/1

(57) ABSTRACT

A pointing system uses a hologram or a lenticular image that may be affixed to a pointing device such as a game controller. The hologram may comprise a holographic image and may display a pattern that changes rapidly and predictably as the position of the pointing device changes. The hologram may be a reflection hologram or a transmission hologram. A light sensing device not on the controller captures the movement and appearance of the hologram and provides information to a computing device. The computing device processes the appearance information to determine an orientation of the pointing device, and based on the orientation, changes the position of a cursor on a display.

### BACKGROUND

A pointing device is an input interface (e.g., a human interface device) that allows a user to input spatial (i.e., continuous and multi-dimensional) data to a computer. Graphical user interfaces (GUIs) allow the user to control and provide data to the computer using physical gestures such as point, click, and drag, for example, by moving a handheld mouse across the surface of a physical desktop and activating switches on the mouse. Movements of the pointing device are echoed on the screen by movements of the pointer or cursor and other visual changes. While the most common pointing device is the mouse, many more devices have been developed.

A game controller is a pointing device used to control a video game and is typically connected to a video game console or a personal computer (PC). A game controller can be a keyboard, mouse, gamepad, joystick, paddle, or any other device designed for gaming that can receive input. Special purpose devices, such as steering wheels for driving games and light guns for shooting games, may also exist for a platform. Some devices, such as keyboards and mice, are actually generic input devices and their use is not strictly limited to that of a game controller. A game controller can be used to govern the movement or actions of an entity in a video or computer game. The type of element controlled depends upon the game, but a typical element controlled would be the player character's actions and movements.

The keyboard and mouse are typical input devices for a PC and are currently the main game controllers for computer games on a PC. The keyboard and mouse achieve greater speed, comfort, and accuracy for the gamer. Some video game consoles also have the ability to function with a keyboard and a mouse. A mouse thus is a handheld pointing device used in addition to the keyboard. For games, the keyboard typically controls movement of the character while the mouse is used to control the game camera or used for aiming.

The mouse is an excellent two-dimensional pointing device, but for some applications, particularly video games, it is not practical, and existing alternatives do not provide the same precision. A specific example is when a video game player needs to indicate the three-dimensional direction in which their character is facing. PC games use the mouse for this task, while console gamers use a joystick, with widely accepted loss of precision. Other game controllers include controller pads and gesture-based controllers.

Some game controllers use accelerometers to measure or infer the approximate orientation and acceleration of the game controller. A built-in camera may be incorporated so that the game controller can be used as a pointing device. These systems have many active components in the game controller, leading to increased cost and complexity.

### SUMMARY

A pointing system uses a hologram that may be affixed to a pointing device such as a game controller. The hologram may comprise a holographic image and may display a pattern that changes rapidly and predictably as the position of the pointing device changes. A light sensing device not on the controller captures the appearance of the hologram and provides information to a computing device. The computing device processes the appearance information to determine an orientation of the pointing device, and based on the orientation, changes the position of a cursor on a display.

In an implementation, the hologram is a reflection hologram. A light source is shone onto the hologram and a light sensing device captures reflected light from the hologram.

In an implementation, the hologram is a transmission hologram. A light source is shone through the hologram and a light sensing device captures emitted light through the hologram.

In an implementation, the hologram may be replaced with a lenticular image.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 is a block diagram of an implementation of a passive pointing system;

FIG. 2 is an operational flow of an implementation of a passive pointing method;

FIG. 3 is a block diagram of an implementation of an active holographic pointing system;

FIG. 4 is an operational flow of an implementation of an active holographic pointing method; and

FIG. 5 shows an exemplary computing environment.

### DETAILED DESCRIPTION

A hologram is an image printed at very high resolution which can contain features smaller than the wavelengths of visible light. Light reflected from, or passing through, a hologram is diffracted, leading to complex patterns of light which change dramatically with viewing position. Holography is often used to create images which appear to have three-dimensional depth; however, a hologram can create more general spatial patterns of light as well. Unlike a normal image, a hologram can provide a large change in appearance in response to a small change in a viewing angle. Thus, the appearance of a hologram may change rapidly with orientation, whereas that of a conventional image or object may not.

Several types of holograms are well known including reflection and transmission holograms. A reflection hologram creates a three-dimensional image when light, such as laser light or white light, reflects off its surface. A transmission hologram creates a three-dimensional image when monochromatic light, or light that is one wavelength, passes through it. Transmission holograms are viewed by shining a light source (e.g., laser light) through them and looking at the reconstructed image from the side of the hologram opposite the light source.

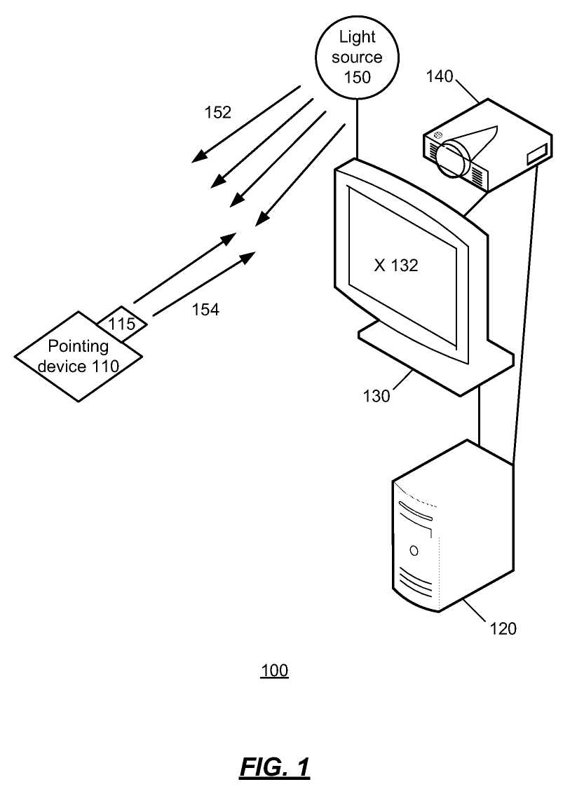

FIG. 1 is a block diagram of an implementation of a pointing system 100. The pointing system 100 is passive in that it may use a reflection hologram 115 that may be affixed to a pointing device 110, such as a game controller. The pointing device 110 may be considered to be an optical pointing device. In an implementation, the hologram 115 may comprise a holographic image and may be affixed to the pointing device 110 using an adhesive. The holographic image may be disposed on an adhesive which is affixed to the pointing device 110. The hologram 115 may display a pattern that changes rapidly as the position of the pointing device 110 changes. Although any holographic image may be used on the hologram 115, the holographic image may be designed to maximize resolution at minimal cost. In an implementation, a hologram 115 may include a superposition of high and low spatial frequency grids to allow high resolution without phase ambiguity.

A computing device 120, such as a PC or a gaming console, may have an associated monitor or display 130. A cursor 132, also referred to as a pointer, as well as a player orientation for example, may be responsive to the pointing device 110 and may be displayed on the display 130. As the pointing device 110 is moved (e.g., by a user), the position of the cursor 132 or player orientation may change on the display 130.

A camera 140 and a light source 150 are also provided. The light source 150 may be disposed on or near the display 130 and may radiate light 152. The light 152 may be received by the hologram 115 and reflected as reflected light 154. The light source 150 may be any type of illuminant that may be reflected by the hologram 115 and captured by the camera 140. The light source 150 may radiate any type of light 152 that may be visible or invisible to a human, such as light provided by an incandescent bulb, an LED, a laser, etc. It is contemplated that any light source that radiates light that may be received by the camera 140 may be used. The camera 140 may comprise any type of light detecting or light sensing device, such as a photodiode, a web camera, or any arrangement of lenses and a charge-coupled device (CCD), for example.

The pointing device 110 may be pointed towards the camera 140. The camera 140 may be mounted on or near the display 130, facing the user of the pointing device 110. The camera 140 may capture the reflected light 154 from the hologram 115 and provide information pertaining to the captured reflected light to the computing device 120. The camera 140 may thus receive information pertaining to the movements of the holographic image of the hologram 115 and provide this information to the computing device 120 for processing.

Based on the information provided by the camera 140, the computing device 120 may infer the relative orientation of the camera 140 and the pointing device 110 (i.e., the hologram 115 on the pointing device 110) to determine the position of the cursor 132. Any known positioning techniques may be used, such as those including speckle, gray codes, and image based hash functions. The geometry between the pointing device 110 and the light source 150 may be considered, as well as the geometry between the pointing device 110 and the camera 140.

Thus, the holographic image on the hologram 115 may be constructed so that its differing appearances follow a predictable pattern as the orientation of the pointing device 110 changes. To determine orientation, the camera 140 captures the appearance of the hologram 115, and the computing device 120 computes the corresponding view orientation. For improved efficiency or accuracy, several holograms may be combined. Determination of the orientation of the pointing device 110 can be based on any known algorithms or techniques. In an implementation, a lookup table may be used by the computing device 120 to look up the pattern projected from hologram 115 into the camera 140 to determine the orientation. The cursor 132 may then be moved based on the determined orientation.

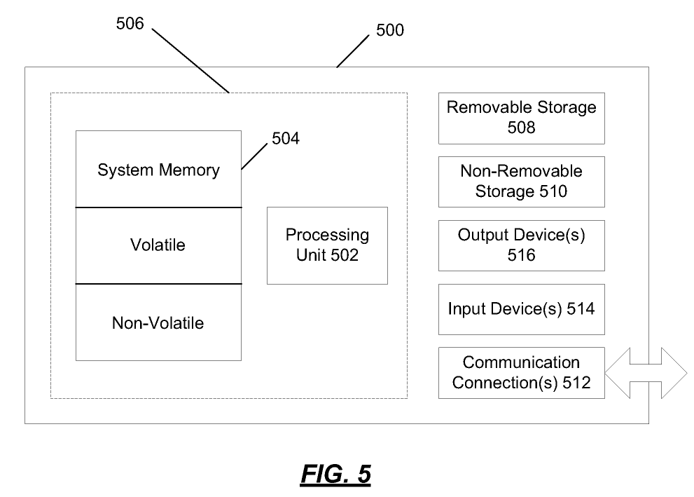

An example computing device is described with respect to FIG. 5. The nature of the hologram 115 is such that a rapidly changing image is presented to the camera 140 as the orientation of the pointing device 110 changes. This is in contrast to a computer vision approach not using a hologram, in which the image presented to a camera changes very slowly with orientation.

The pointing device 110 may comprise any material, device, or component, and is not limited to a game controller. It is contemplated that any material, device, or component may have a hologram 115 affixed to it and may be used as a pointing device 110 in the pointing system 100.

Alternative implementations may use a lenticular image instead of a holographic image. Lenticular printing is a technology in which a lenticular lens is used to produce images with an illusion of depth, or the ability to change or move as the image is viewed from different angles. This technology has evolved in recent years to show more motion and increased depth. In an implementation, a lenticular image comprising multiple interlaced images may be printed onto a substrate that has an adhesive and may be affixed to a pointing device 110. Alternatively, the lenticular image may be printed directly onto a side of the pointing device 110.

As the pointing device 110 with the lenticular image is moved, the camera 150 may receive different images based on the changed orientation of the pointing device 110 and lenticular image. These different images may be processed by the computing device 120 to determine positioning of the cursor 132 on the display 130.

In an implementation, a user may design their own hologram, e.g., by providing user-provided artwork to a computing device which generates a hologram for use with a pointing device. In this manner, personalized holograms may be provided to pointing devices.

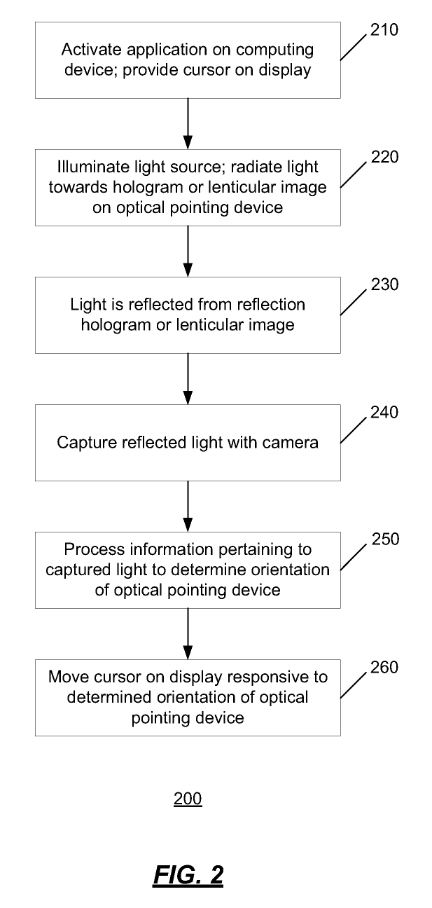

FIG. 2 is an operational flow of an implementation of a pointing method 200. The method 200 may involve a passive pointing system such as the pointing system 100 which may use a reflection hologram 115 or a lenticular image that may be affixed to a pointing device 110. At operation 210, a software application such as a video game may be activated by a computing device and a cursor associated with the application may be provided on a display associated with the computing device.

At operation 220, a light source is illuminated and light is radiated from the light source. The light is reflected from a hologram or a lenticular image affixed to an optical pointing device at operation 230. The reflected light may be captured by a camera at operation 240. In an implementation, a different view of the hologram or the lenticular image may be presented to the camera for each orientation of the pointing device. At operation 250, information pertaining to the captured reflected light may be processed (e.g., by a computing device) to determine the orientation of the optical pointing device. At operation 260, the cursor may be moved on the display in response to the determined orientation of the optical pointing device.

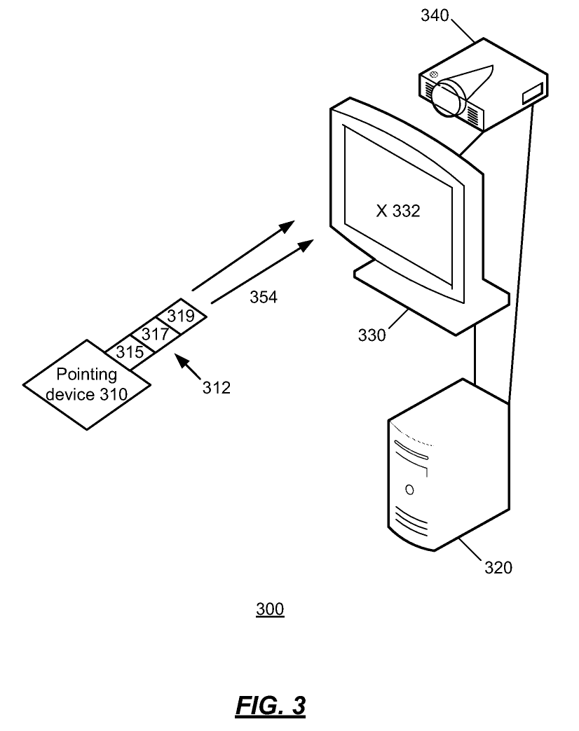

FIG. 3 is a block diagram of an implementation of an active holographic pointing system 300. The holographic pointing system 300 is active in that it uses a transmission hologram 319 that may be affixed to a pointing device 310, such as a game controller. The pointing device 310 may be considered to be an optical pointing device. In an implementation, a holographic projector 312 may be affixed to the pointing device 310, e.g., using an adhesive or other means for attachment. The holographic projector 312 may comprise a light source 315, a lens 317 connected to one end of the light source 315, and the transmission hologram 319 attached to the lens 317.

As with the hologram 115, the hologram 319 may display a pattern that changes rapidly as the position of the pointing device 310 changes, and may include a superposition of high and low spatial frequency grids to allow high resolution without phase ambiguity.

The system 300 may include a computing device 320 with an associated monitor or display 330 on which a cursor 332, player orientation, etc. may be displayed. A camera 340 may also be provided. The computing device 320, the display 330, the cursor 332, and the camera 340 are similar to the computing device 120, the display 130, the cursor 132, and the camera 140 of the system 100 and their descriptions may be omitted for brevity. As the pointing device 310 is moved (e.g., by a user), the position of the cursor may change on the display 330.

The light source 315 may have fixed properties, and may radiate any type of light that may be visible or invisible to a human, such as light provided by an incandescent bulb, an LED, a laser, etc. The fixed properties of the light source 315 along with the known geometry of the pointing device 310 and the holographic projector 312 may be used by the computing device 320 in determining an orientation of the pointing device 310. The orientation may be used by the computing device 320 to position the cursor 332 on the display 330.

The light radiated by the light source 315 may pass through the lens 317 and through the transmission hologram 319 as emitted light 354. The emitted light 354 may be captured by the camera 340 which may be mounted on or near the display 330.

In an implementation, an additional lens may be placed on the side of the transmission hologram 319 opposite the lens 317. In this manner, the light radiated by the light source 315 may pass through the lens 317, the transmission hologram 319, and the additional lens before being emitted as the emitted light 354. Additionally or alternatively, no lens may be provided between the light source 315 and the transmission hologram 319. The light from the light source 315 passes directly to the transmission hologram 319, and then may pass through a lens, or not, prior to being emitted as the emitted light 354.

The camera 340 may capture the emitted light 354 from the holographic projector 312 and provide information pertaining to the captured emitted light to the computing device 320. The camera 340 may thus receive information pertaining to the movements of the holographic image of the hologram 319 affixed to the pointing device 310 and provide this information to the computing device 320 for processing.

Similar to that described with respect to the system 100, based on the information provided by the camera 340, the computing device 320 may determine the relative orientation of the camera 340 and the pointing device 310 to determine the position of the cursor 332. Any known positioning techniques may be used.

To determine orientation of the pointing device 310, the camera 340 captures the appearance of the hologram 319, and the computing device 320 computes the corresponding view orientation. Determination of the orientation can be based on any known algorithms or techniques. The cursor 332 may be moved based on the determined orientation.

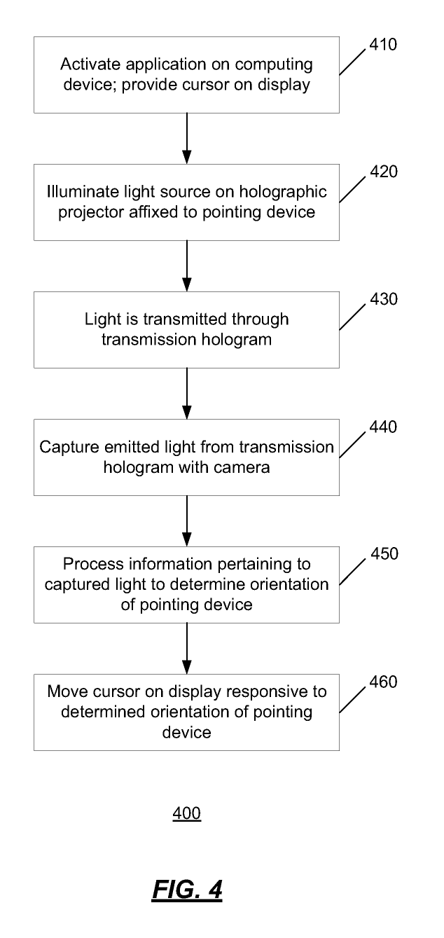

FIG. 4 is an operational flow of an implementation of an active holographic pointing method 400. The method 400 may involve an active holographic pointing system such as the holographic pointing system 300 which uses a transmission hologram 319 that may be comprised within a holographic projector 312 that may be affixed to a pointing device 310. At operation 410, an application may be activated by a computing device and a cursor associated with the application may be provided on a display associated with the computing device.

At operation 420, the light source in the holographic projector may be illuminated. The light passes through the lens and through the transmission hologram that is affixed to a pointing device at operation 430. The emitted light may be captured by a camera at operation 440. In an implementation, a different view of the hologram may be presented to the camera for each orientation of the pointing device. At operation 450, information pertaining to the captured light may be processed to determine the orientation of the pointing device. At operation 460, the cursor may be moved on the display in response to the determined orientation of the pointing device.

FIG. 5 shows an exemplary computing environment in which example implementations and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, PCs, server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 5, an exemplary system for implementing aspects described herein includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as read-only memory (ROM), flash memory, etc.), or some combination of the two. This most basic configuration is illustrated in FIG. 5 by dashed line 506.

Computing device 500 may have additional features/functionality. For example, computing device 500 may include additional storage (removable and/or non-removable) including, but not limited to, magnetic or optical disks or tape. Such additional storage is illustrated in FIG. 5 by removable storage 508 and non-removable storage 510.

Computing device 500 typically includes a variety of computer readable media. Computer readable media can be any available media that can be accessed by device 500 and include both volatile and non-volatile media, and removable and non-removable media.

Computer storage media include volatile and non-volatile, and removable and non-removable media implemented in any method or technology for storage of information such as computer readable instructions, data structures, program modules or other data. Memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 500.

Computing device 500 may contain communications connection(s) 512 that allow the device to communicate with other devices. Computing device 500 may also have input device(s) 514 such as a keyboard, mouse, pen, voice input device, touch input device, etc. Output device(s) 516 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A pointing method, comprising:
disposing a hologram or a lenticular image on a pointing device;
capturing light from the hologram or the lenticular image; and
moving a cursor on a display based on the light captured from the hologram or the lenticular image.

2. The method of claim 1, wherein the hologram comprises a reflection hologram.

3. The method of claim 2, further comprising illuminating a light source to radiate light towards the reflection hologram or the lenticular image.

4. The method of claim 3, wherein capturing light from the hologram or the lenticular image comprises capturing light reflected from the reflection hologram or the lenticular image.

5. The method of claim 1, wherein the hologram comprises a transmission hologram.

6. The method of claim 5, wherein the pointing device comprises a holographic projector comprising a light source and the transmission hologram.

7. The method of claim 6, wherein capturing light from the hologram comprises capturing light emitted from the transmission hologram.

8. The method of claim 1, further comprising determining an orientation of the pointing device based on information pertaining to the light captured from the hologram or the lenticular image, wherein moving the cursor is based on the determined orientation of the pointing device.

9. A pointing system, comprising:
a pointing device comprising a hologram or a lenticular image; and
a computing device that determines an orientation of the pointing device based on information pertaining to light captured from the hologram or the lenticular image.

10. The system of claim 9, further comprising a display having a cursor displayed thereon based on the determined orientation of the pointing device.

11. The system of claim 9, wherein the hologram comprises a reflection hologram.

12. The system of claim 11, further comprising a light source that radiates light towards the reflection hologram.

13. The system of claim 12, further comprising a light sensing device that captures light reflected from the reflection hologram and provides the information to the computing device.

14. The system of claim 9, wherein the hologram comprises a transmission hologram.

15. The system of claim 14, wherein the pointing device comprises a holographic projector comprising a light source and the transmission hologram.

16. The system of claim 15, further comprising a light sensing device that captures light emitted from the transmission hologram and provides the information to the computing device.

17. An optical pointing device, comprising:
a pointing device; and
a hologram or a lenticular image affixed to the pointing device.

18. The device of claim 17, wherein the hologram comprises a reflection hologram.

19. The device of claim 17, wherein the hologram comprises a transmission hologram.

20. The device of claim 19, further comprising a holographic projector comprising a light source and the hologram, the holographic projector affixed to the pointing device.
